(19) United States
(12) Patent Application Publication
(10) Pub. No.: US 2012/0316818 A1
(43) Pub. Date: Dec. 13, 2012

(54) SYSTEM FOR MONITORING MULTI-ORDERABLE MEASUREMENT DATA

(75) Inventors: Robert J. Baseman, Brewster, NY (US); William K. Hoffman, Pleasant Valley, NY (US); Steven Ruegsegger, Jericho, VT (US); Emmanuel Yashchin, Yorktown Heights, NY (US)

(73) Assignee: International Business Machines Corporation, Armonk, NY (US)

(21) Appl. No.: 13/588,534

(22) Filed: Aug. 17, 2012

Related U.S. Application Data
(62) Division of application No. 12/164,603, filed on Jun. 30, 2008.

(51) Int. Cl. G06F 19/00

(52) U.S. Cl. 702/82

(57) ABSTRACT

A computer-based measurement monitoring system and method for monitoring multi-stage processes capable of producing multi-orderable data and identifying, at any stage in the monitored process, unacceptable deviations from an expected value at particular stages of the process, and communicating same detected deviation to facilitate corrective action in the process. The system and method consolidate data obtained at various stages of the process, arrange the measurement data in a multi-orderable data framework, compare the multi-orderable framework data with expected parameter values corresponding to the various stages, and detects-unacceptable deviations from the expected values. The unacceptable deviations are communicated to responsible personnel, and the system and method provides same personnel with supplemental information useful in diagnosing the root cause of the problem leading to the detected deviations.

### RELATED APPLICATIONS

This application is a divisional of U.S. application Ser. No. 12/164,603, filed Jun. 30, 2008.

### BACKGROUND OF THE INVENTION

The invention relates to monitoring manufacturing and other types of processes, and more particularly relates to a system and method for monitoring a process, by monitoring measurement data collected at various stages of the process, arranging the measurement data in a multi-orderable data framework, comparing multi-orderable framework data with expected parameter values corresponding to the various stages, detecting any unacceptable deviations from the expected values in the multi-orderable framework, communicating same to responsible personnel and providing supplemental information useful in diagnosing the root cause of the problem responsible for the unacceptable deviation to the noticed responsible personnel.

Manufacturing and other types of processes are known for processing raw materials through various stages of development to realize a finished product. For example, a process, or sets of processes for manufacturing a semiconductor integrated circuit (IC) operate upon a silicon wafer to evolve the wafer through various manufacturing stages to realize the specified IC. The manufacturing process is detailed, requiring many complex steps. Processing a wafer to an operable IC requires at times hundreds of process steps such as lithographic patterning, etching, etc. Controlling the process, or processes involved includes monitoring characteristic parameters of a manufactured product (e.g., an IC), and adjusting the process where necessary to realize the specified product.

Faults readily occur on the manufacturing tools that implement the various process steps in a semiconductor IC manufacturing process. A fault on a single wafer can compromise all of the IC devices comprising the wafer, and all subsequent processing steps performed on the wafer may be in vain, the faulty IC wafer discarded. Timely, effective fault detection is necessary to avoid unnecessary cost in materials and manufacturing effort. For that matter, fault detection in manufacturing equipment is known. For example, U.S. Pat. No. 7,062,411, issued Jun. 13, 2006, discloses a method of fault detection on a semiconductor manufacturing tool by monitoring tool sensor output, establishing a fingerprint of tool states based on a plurality of sensor outputs, capturing sensor data indicative of fault conditions, building a library of the fault fingerprints to identify a fault condition and estimating an effect of such a fault condition of process output. The fault library is constructed by inducing faults in a systematic way, or by adding fingerprints of other known faults as they occur.

Known manufacturing and similar process monitoring systems, however, while constantly seeking to determine a definitive fault condition fail to notice deviations in expected results that precede a full fault condition, or fail to notice that step in the process where unacceptable deviation in an expected output indicates that without adjustment, that the manufactured output will likely be faulty. The present invention overcomes the shortcomings of such known process monitoring systems by detecting deviations in order to adjust the process and avoid proceeding to the full fault condition.

### SUMMARY OF THE INVENTION

To that end, the present invention discloses a process monitoring system and method that, by utilizing multi-orderable data, overcome the shortcomings of prior art monitoring systems and methods.

In one embodiment, the invention includes a method for monitoring a manufacturing process comprising a number of process stages in order to maintain manufacturing process output at a specified quality standard by monitoring data derived from each process stage and arranged in a multi-orderable framework, and detecting whether multi-orderable data from each process stage is within specified acceptable range. The method includes, for each process stage, arranging the measurement data from said process stage in a multi-orderable data framework, for each process stage, monitoring the multi-orderable measurement data, comparing the real-time multi-orderable data with expected parameter values corresponding to said each process stage, detecting unacceptable deviations from the expected parameter values for said each process stage, and communicating the detected unacceptable deviations.

The step of communicating includes notifying appropriate manufacturing personal that there is unacceptable deviation in said process stage. The method may also include generating supplemental information useful in identifying the root causes of the unacceptable deviation using said multi-orderable data and communicating said supplemental information to manufacturing personnel in an effort to support an effort by the manufacturing personnel to remedy the deviation. The step of arranging the measurement data from said process stage in a multi-orderable data framework includes setting a parameter value representative of a deviation from an expected value and the step of monitoring the multi-orderable measurement data monitors for said parameter value representative of the deviation from said expected value.

The method also includes establishing recency of condition detected and flagged in the multi-orderable data that indicate a deviation. The step of establishing recency includes one-sided analyses and two-sided analyses, and the step of communicating includes generating a list of outcomes for each of the monitored process stages. The step of monitoring the multi-orderable measurement data for each process stage includes a step of statistical analysis to multi-orderable data streams. The step of detecting unacceptable deviations from the expected parameter values for said each process stage is based on a procedure for establishing acceptable and unacceptable parameter levels associated with each said process stage, using a magnitude determining function.

In another embodiment, the invention includes a system for monitoring a manufacturing process comprising a number of process stages by monitoring measurement data acquired for each stage and arranged in a multi-orderable framework in order to detect, by processing the multi-orderable framework data for each process stage, whether process stages are operating in an acceptable range. The system includes a job specification module (JSM) for receiving specifications of the data source that provides data in the multi-orderable data, and processing the multi-orderable data to specify test objects for which the measurement for monitoring are defined, a data processing module (DPM) for receiving the test objects specified by the job specification module and multi-orderable data, and processing the module and data to generate reports and tables and an output database for storing the generated reports and tables.

A report processing module for processing data comprising the output database to select conditions to be flagged, derived from the multi-orderable measurement data comprising each process stage, and assigning the conditions to be flagged ranking factors, a user interface module that organizes data for presentation to a user, and accepts user input and a correction module that operates in coordination with the user interface module to introduce modifications to the specified test objects, which modifications are one of: automatically defined by the system, and user defined. The job specification module (JSM) preferably comprises a test object specification module, a processing station specification module, a measurement station specification module, a function specification module, a parameter specification module and a parameter generating module (PGM). The parameter generating module receives multi-orderable data, and processes the multi-orderable data to select the parameters for monitoring.

### BRIEF DESCRIPTION OF THE DRAWING FIGURES

The foregoing and other objects, aspects and advantages will be better understood from the following detailed description of embodiments of the inventions, with reference to the drawings, in which:

FIG. 1 is a representation of a general purpose computer into which has been provided a set of computer instructions for implementing the inventive method for monitoring multi-orderable data;

FIG. 2 is a schematic block representation of one embodiment of a system for monitoring multi-orderable measurement data of the invention;

FIG. 3A is a plot depicting an example of data for a variable v006, depicted in Table 2;

FIG. 3B is a plot illustrating properties of a trend revealing transform performed on the data depicted in Table 2;

FIG. 4 depicts another embodiment of a system for monitoring multi-orderable measurement data (400) of the invention;

FIG. 5 depicts one embodiment of JSM (403), which is one component of the system for monitoring multi-orderable measurement data (400) of the invention;

FIG. 6 depicts operation of PGM (506); and

FIG. 7 depicts operation of data processing module (DPM; 404).

### DETAILED DESCRIPTION

The present invention comprises a computer-based measurement monitoring system and method for monitoring multi-orderable data generated by a manufacturing process and identifying, at any stage in the manufacturing process, unacceptable deviations from an expected value at particular stages of the process through the use of the multi-orderable data, and communicating same detected deviation to facilitate corrective action in the process. The system and method monitor measurement data in real-time at various stages of the process, arrange the real-time measurement data in a multi-orderable data framework, compare the real-time multi-orderable framework data with expected parameter values corresponding to the various stages, and detect-unacceptable deviations from the expected values. The unacceptable deviations are communicated to responsible personnel, and the system and method provides same personnel with supplemental information useful in diagnosing the root cause of the problem leading to the detected deviations.

The novel system and method acquire data, or data points, sampled at predetermined stages in an operational process being monitored, and arrange the various sampled data points in a form of multi-orderable measurement data to facilitate efficient detection of unacceptable deviations from an expected results at each of the process stages. The multi-orderable measurement data is maintained as a list or table, and a graphical user interface function presents the list or table in a form that readily communicates to the user the multi-orderable measurement data as the data becomes available at each process stage. The GUI interacts with an engineer/user to configure a monitoring scheme for each manufacturing process that will be monitored by the inventive system or method, in association with the list or table.

As new measurement data is captured at the various stages of the monitored process, the data are arranged in the list or table in the multi-orderable framework. Each new data entered in the table or list is processed and compared to an expected data value for the processing stage corresponding to the new data determine whether the process is operating as expected. If the result of the comparing suggests that the state of the process at sampled processing stage has deviated from the expected result beyond what is acceptable, the method and system flag the new data, and generate a message to communicate that there is an indication that process is unexpectedly deviating. Based on the message, immediate corrective remedial action becomes possible. To support the corrective, remedial action, the invention communicates supplemental information to support diagnosing the root cause of the deviation.

For explanation purposes, the invention is described in detail with respect to a semiconductor integrated circuit (IC) manufacturing, or fabrication process. The skilled artisan should note, however, that the invention is not limited to application to semiconductor manufacturing processes, but can be implemented in any manufacturing or service process, or processes that require monitoring of measurements acquired in same process or processes. A semiconductor manufacturing process is particularly suited as a representative process that may be operated upon by the system and method of this invention because in a semiconductor manufacturing process, any given measurement (i.e., any data sampled at one stage in the semiconductor manufacturing process) may be influenced by a large number of tools, or process steps.

In such a semiconductor fabrication process framework, it is important to detect that sampled parameter values are not correlated to the expected parameter values for a particular stage in the process, in the schema defined by the engineer/user, to timely identify such unacceptable deviations from expected results as early as possible in the process, to notify appropriate personal, or application programs to identify the factors affecting the detected deviation, and adjust process parameters related to the factors to better control them. That is, through the GUI, the inventive system and method make pertinent supplemental information useful in diagnosing a root cause of the detected, unexpected process result available to the user/engineer for troubleshooting. To that end, the inventive system and method further includes a feature whereby false alarms (i.e., false interpretations that sampled parameter values at a point in a process have shown unexpected results) are minimized to an acceptable false alarm rate.

The various method embodiments of the invention will be generally implemented by a computer executing a sequence of program instructions for carrying out the steps of the method, assuming all required data for processing is accessible to the computer. The sequence of program instructions may be embodied in a computer program product comprising media storing the program instructions. As will be readily apparent to those skilled in the art, the present invention can be realized in hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and executed, carries out the method, and variations on the method as described herein. Alternatively, a specific use computer, containing specialized hardware for carrying out one or more of the functional tasks of the invention, could be utilized.

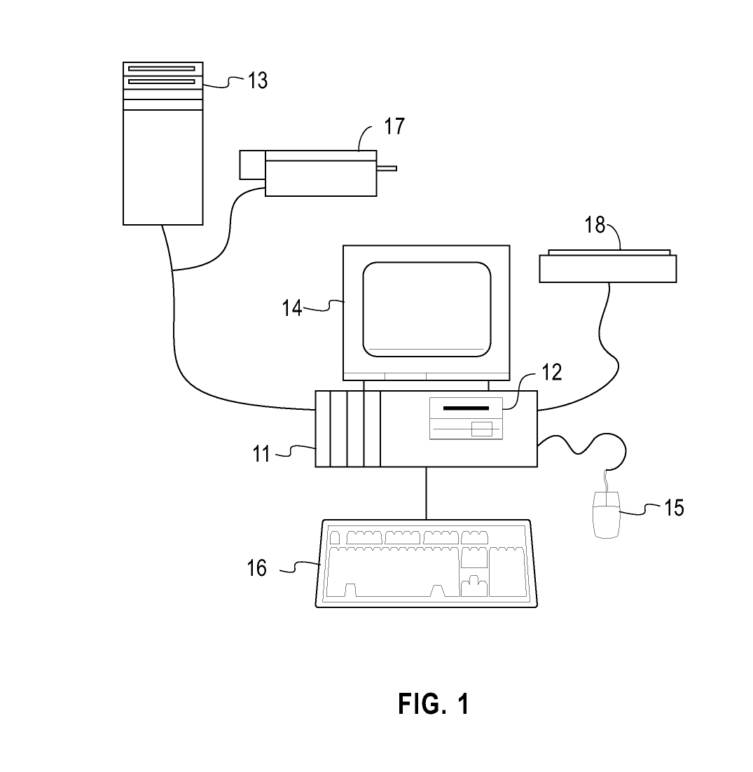

A computer-based system (10) is depicted in FIG. 1 herein by which the method of the present invention may be carried out. Computer-based system (10) includes a processing unit (11), which houses a processor, memory and other systems components (not shown expressly in the drawing figure) that implement a general purpose processing system, or computer that may execute a computer program product. The computer program product may comprise media, for example a compact storage medium such as a compact disc, which may be read by the processing unit (11) through a disc drive (12), or by any means known to the skilled artisan for providing the computer program product to the general purpose processing system for execution thereby.

The computer program product comprises all the respective features enabling the implementation of the methods described herein, and which—when loaded in a computer system—is able to carry out these methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The computer program product may be stored on hard disk drives within processing unit (11), as mentioned, or may be located on a remote system such as a server (13), coupled to processing unit (11), via a network interface such as an Ethernet interface. Monitor (14), mouse (15) and keyboard (16) are coupled to the processing unit (11), to provide user interaction. Scanner (17) and printer (18) are provided for document input and output. Printer (18) is shown coupled to the processing unit (11) via a network connection, but may be coupled directly to the processing unit. Scanner (17) is shown coupled to the processing unit (11) directly, but it should be understood that peripherals might be network coupled, or direct coupled without affecting the ability of the processing unit (11) to perform the method of the invention.

### Multi-Orderable Measurement Data

Multi-orderable measurement data derived from sampling, or otherwise collecting specified data representative of process state at the predetermined process stages are represented in a table, such as an exemplary Table 1 below. Exemplary Table 1 highlights multi-orderable measurement data acquired from a semiconductor manufacturing process in accordance with the user/engineer defined monitoring schema for an exemplary semiconductor manufacturing process. That is, based on the monitoring schema definition, data is accumulated over time, at the various time-dependent manufacturing stages, and the table populated with the data as it becomes available. Because the data represent the state of the process at a various time-dependent stages, Table 1 is shown partially completed to represent that the table provides the desired “snapshot” of the process state at the time it is viewed.

In semiconductor process monitoring schema defined by Table 1, the rows of the table correspond to each particular measurement (measurement ID) for each process stage of interested. A single row of the table corresponds to a measurement, or a group of measurements taken in the course of a semiconductor manufacturing process, in which the ICs are mostly processed as parts of wafers, and the wafers normally processed as part of lots. Columns comprise three groupings for each process stage or measurement. In more detail, the first grouping in Table 1, columns “Obs,” “Lot” and “Wafer,” indicate that at the fixed stage in the process, the ID of the lot, and the wafer from which the measurement data is derived define the measurement data thereunder. For the second grouping, three measurements Meas 1, Meas2 and Meas3, represent actual measurements derived for a wafer, for example, W1 in line 1 (Obs 1). Tool1, Tool2, and Tool3 represent specific tools, the wafer-processed outputs of which were quantified by the measurements, and the times at the stage in which the measured data is collected with respect to each tool.

TABLE 1

| Obs | Lot | Wafer | Meas1 | Meas2 | Meas3 | Tool1 | Tool2 | Tool3 |
|---|---|---|---|---|---|---|---|---|
| 1 | Abc123 | W1 | 12.3 | 0.85 | | 2003-06-12 13:50 | 2003-06-18 09:15 | 2003-06-20 11:03 |
| 2 | Abc123 | W2 | 12.7 | 0.87 | | 2003-06-12 15:20 | 2003-06-18 09:15 | 2003-06-20 14:12 |
| 3 | Abc123 | W3 | 12.5 | 0.83 | | 2003-06-12 17:30 | 2003-06-18 09:15 | |
| 4 | Abc123 | W4 | 11.3 | 0.81 | | 2003-06-12 19:15 | 2003-06-18 09:15 | |
| 5 | Abc123 | W4 | | | 3.83 | 2003-06-14 12:15 | | |
| 6 | Abc124 | W1 | | | 3.73 | | | |
| 7 | Abc124 | W2 | | | 3.81 | | | |
| 8 | Abc124 | W3 | | | 3.80 | | | |
| 9 | Abc124 | W4 | | | 3.73 | | | |
| 10 | Abc125 | W1 | | | 3.77 | | | |
| 11 | Abc125 | W2 | | | 3.81 | | | |
| 12 | Abc125 | W3 | | | | 2003-06-12 13:50 | | |
| 13 | Abc125 | W4 | | | | | | |
| 14 | Abc126 | W1 | 11.7 | 0.85 | | 2003-06-13 23:12 | 2003-06-20 09:15 | |
| 15 | Abc126 | W2 | 11.9 | 0.82 | | 2003-06-13 23:15 | 2003-06-20 09:15 | |
| 16 | Abc126 | W3 | 12.3 | 0.88 | | 2003-06-13 23:30 | 2003-06-20 09:18 | |
| 17 | Abc126 | W4 | 12.7 | 0.80 | | 2003-06-13 23:35 | | |
| 18 | Abc126 | W4 | | | 3.82 | 2003-06-13 10:15 | | |
| 19 | Abc127 | W1 | | | 3.84 | 2003-06-13 12:25 | | |
| 20 | Abc127 | W2 | | | 3.77 | | 2003-06-22 09:15 | |
| 21 | Abc127 | W3 | | | 3.80 | | 2003-06-22 09:18 | |
| 22 | Abc127 | W4 | | | 3.78 | | 2003-06-22 09:23 | |
| 23 | Abc128 | W1 | | | 3.87 | | 2003-06-23 18:15 | |
| 24 | Abc128 | W2 | | | 3.75 | | 2003-06-23 18:25 | |
| 25 | Abc128 | W3 | | | 3.77 | | 2003-06-23 18:30 | |
| 26 | Abc128 | W4 | | | 3.72 | | 2003-06-23 18:35 | |

As mentioned, before operating the system and method to monitor a manufacturing process, the monitoring schema (and table representative of the schema) is configured at least partially pursuant to an engineering request. Using a graphical user interface (GUI), an engineer/user completes any configuring requiring user input. The engineering request specifies a collection of measurements to be explored (in this case, they are named Meas 1, Meas2, Meas3) and a collection of tools that the wafers operated upon by the various stages of the process have been exposed to. The configuring requires defining the paths, or data feeds to the data required to populate a table and present the measurements, and related information in the tabled form of multi-orderable data.

In Table 1, a state of the process as of 2003-06-23, and includes all of the data that are available on the same 2003-06-23 date. While the entries in columns Meas 1, Meas2 and Meas3 represent scalar quantities, the table data cells also could contain a vector measurement. For that matter, Meas 1 and Meas2 of the first row of Table 1 corresponds to a pair of measurements (12.3; 0.85) that were taken as a vector quantity for wafer W1 from lot Abc123 with respect to three specific tools: named Tool1, Tool2 and Tool3, comprising the processing times at which the measurements were taken. Note that some of the wafers have seen all three tools, but other wafers (especially those corresponding to newer lots) have only seen two, or just one tool.

Every multi-orderable data table (of type shown in Table 1) evolves as the time progresses, i.e., as the process progresses over time, the table is populated with data as the data become available. That is, while the data comprising Table 1 correspond to the state of the process existing on 2003-06-25, the table would normally be further developed as processing continues through the various stages, and data is sampled or otherwise derived with respect to same various subsequent processing stages to update the table. In a subsequent table view two (2) days later, on 2003-06-25 (i.e., 2 days later), Table 1 would be expected to contain some new rows corresponding to additional lots/wafers for which the measurements (Meas1-3) become available, as well as additional entries in some rows. For example, since 2003-06-23, particular wafers of lot Abc126 might have been exposed to Tool3, with time stamps appearing in the relevant rows, in accordance with the inventive principles. Some rows containing information on older lots/wafers could also be expected to be missing in tables corresponding to later stages, and later points in time, as these lots/wafers depart the production control system.

It is also important to note that inventive system and method have the capability to represent a more complex entity. For example, Tool1 in Table 1 could be representative of “LithoEtch_Andromeda_Chamber1,” where LithoEtch corresponds to the Operation ID, Andromeda corresponds to the name of the tool, and Chamber1 corresponds to the name of the chamber. For that matter, the multi-orderable data may be presented in a table such as exemplary Table 1 in other forms. Such other forms may include a database, a collection of simpler tables such as a table for each grouping for easy aggregation of data, e.g., by Operation ID, as long as the collection of multi-orderable data comprising the table, or multiple tables, presents opportunities for detection of unfavorable trends in the production process.

The inventive capability to detect unfavorable trends in a production process derives from the special property of the data (multi-orderability) that allows for every sequence of measurements to be ordered in accordance with time stamps related to individual tools (or sometimes even processing steps within tools), and that an analysis of such ordered sequences can reveal time-defined states, including unfavorable process state changes at a particular monitored stage, and bring same detection to attention. The invention in such instances automatically provides information relating to the unacceptable deviation from the expected result at a stage to support understanding the nature of, or cause of the unexpected results at the monitored stage. The inventive system identifies and analyzes related tables, or collections of tables to (a) establish whether a particular sequence of measurements is within acceptable variation; (b) conduct diagnostic activities related to detected flagged situation; and (c) establish relevance of the detected condition

By way of the exemplary multi-stage semiconductor manufacturing process, the sequence of lots/wafers operated upon by the process can take several months, where individual lots proceed at different paces. And as mentioned, measurements taken for selected lots or wafers are summarized in multi-orderable tables of the type shown in Table 1. The novel system and method (a) process the complete (or partial, if specified by the user) set of multi-orderable tables in response to manual, scheduled, event-driven or “on-demand” requests; (b) produce pre-specified outputs characterizing the run (logbooks, charts, tables, error reports, etc), (c) flag certain sets of measurements as non-conforming, as the case may be, (d) rank the flagged sets in accordance with “ranking factors” that characterize the deviation between expected and sampled results (i.e., the flagged conditions) to an engineer and (e) provide supplemental information to help the engineer to diagnose the flagged conditions (i.e., unexpected results).

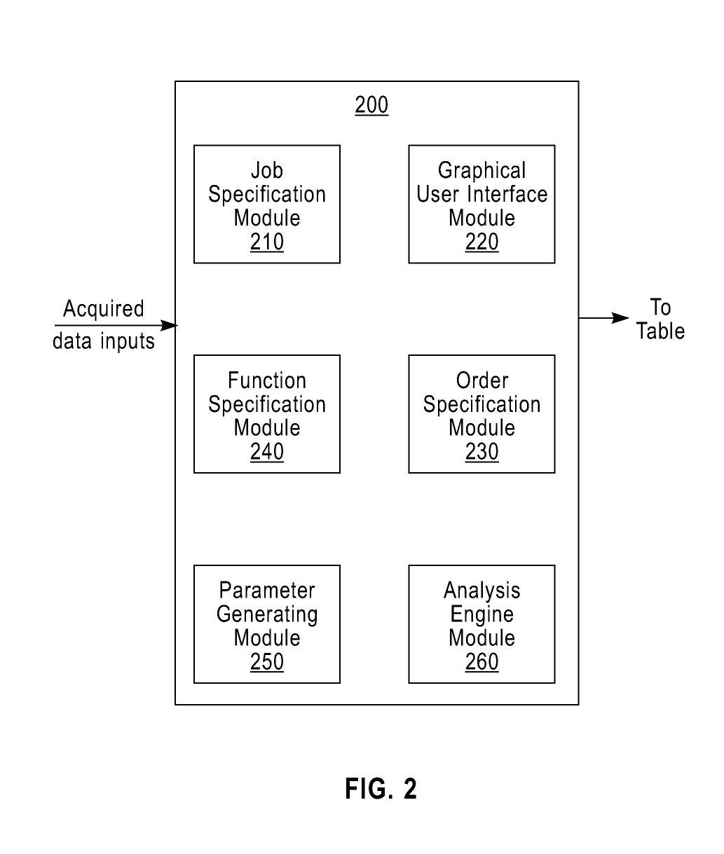

Referring now to FIG. 2, monitoring system (200) of the invention is shown to include a job specification module (210) that operates with a graphical user interface module (220) to enable the engineer/user to specify the measurements to comprise the acquired observations. The inventive method implements the function provided by the job specification module (210). The job specification module defines the data comprising the list that will be populated over time at the various process stages, typically based on an understanding of similar processes, and what detectable data are significant, with respect to the monitored process. Detectable data significant to the monitored process comprises that data known to provide the surest indication that the process may be inadvertently deviating away from expected values, indicating that without correcting input, continuing the process could result in unusable product.

During operation, the job specification module (210) enables the engineer/user to call a function specification module (240) to select objects (products), for example, by pointing and clicking with their cursor in a display image presented by the GUI (230). Function specification module (240) operates to allow the user/engineer to specify the type of a function applied to measurements to create a sequence of observations to which the detection algorithm is applied. For example, function specification module (240) measures wafer-to-wafer variability of silicon oxide film thickness in a lot of semiconductor wafers. The function specification module (240) receives the measured data as an input, and processes it to compute the measurement averages for every wafer in the lot. The function specification module (240) would further process to compute the overall average of measurements within the lot. Further, the function specification module (240) computes the measure of dispersion between the wafer averages, relative to the lot average, and subtracts from this measure a part that is explained by within-wafer variability.

This type of computation is executed for every timestamp ordering. From the computed results, the invention discerns a particular tool that is a most-likely contributor to the erroneous, or out of calibration increase in wafer-to-wafer variability within the lot in view of the fact that the data (processed by the function specification module (240)) is known to be recorded in a given time segment relevant to this particular tool. The data may also evidence that some “other” tool is a “lesser” contributor to the wafer-to-wafer variability where the data ordered in accordance with the “other” tool does not show the same high level of ranking factors used in the diagnostics.

As in the example, the test objects may be defined as individual wafers or lots of wafers. After selecting the test objects, the user/engineer then selects stations, measurements of interest and functions of interest. It should be noted that test objects could be packets of information that are traversing a communication network. In that case, for every packet there will be time stamps related to major stations (e.g., routers, acting as “stations”) that this packet encountered along the way. This setup could also be represented as a multi-orderable data stream, and an objective could be to detect routers that are adversely impacting network performance.

Hence, and without limitation, the job specification module (210) and GUI (220) together enable the user to define the product to be sampled, e.g., which wafers from which batch, to define the measurement data, e.g., meas 1 of Table 1, including scalar or vector quantities sampled, or detected from the product by process at the specified stage monitored (observed). For example, after an etching or ion implantation process stage, the system would acquire data indicating a detected impurity level per unit. Note that the system will frequently process the same set of measurements with respect to several sets of tools that could potentially be related to it, including both production tools and measurement tools. In general, the term “process stage” could relate to measurement tools as well.

The GUI module (220) further operates with an order specification module (230) to specify, for each, or any given type of measurement defined using the job specification module (210), a collection of tools that are understood by the engineer/user as likely to modify the product such that the measurement taken at a particular process stage (subsequent to processing) by the selected tools is likely to be relevant to monitor for deviation of expected results (in that process stage). A parameter-generating module (250) interacts with the user/engineer to generate a parameter specification file. The parameter specification file comprises the parameters that define the rules that control which sequences of observations are flagged for each monitoring schema.

These rules are applied to every ordering in the multi-orderable set that is pre-specified to be of interest. Typically, the same set of rules is applied to each ordering, though the parameter specification file could treat certain orderings in a special way. Note that if the data generally conforms to an unacceptable process level, then it is likely to be flagged for a number of possible orderings. The role of the ranking factors then is to drive the engineering attention to the stations that are considered of special importance with respect to the detected condition, e.g., primary contributors of causal influence.

The parameter specification file is generated substantially automatically, based on very limited input from the user through the GUI. That is, the system is in communication with a user that it cannot, based on the data alone, judge whether the detected conditions would be of any practical significance. The parameter specification file, therefore, offers the user an option where such results (of any practical significance) could indeed be presented, but only if the user is willing first to provide some “minimal” input. This minimal input is specified in the input parameters by the automated input mode. Therefore, while not a default file, the parameter specification file is defined with a minimal extent based on the user's input. The user's input should reflect the user's knowledge about what types of deviations are considered practically significant. It should be noted that the novel system and method is evidence-based, operating on the “practical significance”, and not “statistical significance”. Practical, or evidence-based significance is important because conditions flagged based on statistical significance generally tend to be of limited value to the user.

In additional embodiments, however, the parameter specification file could be activated in a completely automated mode, where it could infer, based on the available data, what should be the engineering requirements for monitoring the multi-orderable data stream (or parts of this stream), eliminating the need for even “minimal” input from the user. For example, it could use the available models that relate the measurements to some product characteristics (such as yields or performance characteristics, or metrology data for which various process capability indices are mandated by the manufacturing process specifications). In the presence of such relations, the “minimal” input may be adequately inferred; the acceptable false alarm rates could also be inferred from what the system knows about the resources (human or other) that are available to attend to the flagged conditions. Under such conditions, the system and method can ensure that the set of flagged conditions is practically manageable if the multi-orderable data stream is within acceptable range. Even in the absence of such relations, it is sometimes useful to let the system infer the “minimal” input from the variability characteristics of the multi-orderable data itself, enabling an automated operation.

The method and system additionally enables the “users” to be automatically generated by other parts of the underlying manufacturing or service process. For example, a new part of the process may be set up to automatically summarize variables that are to be handled in multi-orderable format and prepare the job specification (including parameter specification), so that the system automatically initiates regular processing corresponding to the new part. Such artificially produced “users” are separately marked, so that the system administration is aware of the possibility that job setups corresponding to such users may require administrative intervention.

The parameter-generating module (250) specifies parameters needed to apply the trend-revealing transforms and the thresholds. As a special case, one can use a Cusum-Shewhart scheme as a trend-revealing transform. For a given application, once sequences of observations (variables) are defined, related trend-revealing transforms, and the related parameters are defined. A trend-revealing transform is a recipe for transforming a given set of variables to the sequence of scheme values {s₁, s₂, . . . , s_{T}}, which reflects a state of the monitored process at consecutive points in time. These scheme values are generally non-negative, and tend to increase in response an onset of a trend interested in being detected. A threshold is applied and sequences crossing the threshold are selected, where in many situations the same threshold can be applied to every ordering, further simplifying the approach.

As used herein, a trend may include (a) a change in the mean deposited oxide film thickness by an amount exceeding 10 Angstrom; (b) onset of a drift in the wafer-to-wafer variability within a lot by an amount exceeding 1 Angstroms per day. The trends are essentially defined based on the user's experience for a given set of objects under test. Trend revealing transforms are applied to every variable and relevant ordering. As used herein, variables may represent without limitation (a) sequence of wafer averages; (b) sequence of lot averages; (c) sequence of lot-to-lot variability estimates; and (d) sequence of “within-wafer” variability estimates. The relevant orderings could represent timestamp orders with respect to selected tools that could, in principle, be either themselves culprits, or considered to be of diagnostic value.

In more detail, orderings can exist that are considered a-priori irrelevant. For example, given a particular measurement such as metal film thickness in a metallization phase of the wafer fabrication, one could order the data in accordance with the device fabrication step that happened 1 month prior to the instant testing. However, if tools involved in device fabrication were deemed to be highly unlikely to cause problems with metal film thickness deposited 1 month later, then such an ordering would be considered irrelevant (though technically possible). Allowing the (experienced) user the opportunity to select a subset of relevant orderings helps to reduce the false alarm rate.

Analysis engine module (260) executes runs based on specified monitoring applications with completely or partially specified parameter file. As used herein, a run is a request to the Data Processing Module (DPM) to perform an analysis of the multi-orderable data source based on the specified set of “relevant” orderings and the parameter file. In some cases the parameter file is only partially completed (to a “minimal” extent) and the run will first involve auto-completion of this file. Full-scale production runs will typically operate upon a fully completed parameter file. For that matter, runs are capable of auto-completion of partially specified parameter files. The analysis engine produces logbooks, plots, tables, reports and other output that is necessary to produce tables such as Table 2, herein, described in detail below. The analysis engine output efficiently communicates processing results. Every row of Table 1 contains a user-defined sorting field, and a respective ranking factor, each characteristics of the flagged condition to order the output list (e.g., Table 1).

Sorting fields are the attributes of a flagged condition inherited from the data sources (for example, Lot ID, Wafer ID, Tool ID, etc.). As used herein, a flagged condition is a result of the run of the system. A flagged condition corresponds to a particular trend-revealing transform crossing a threshold. Flagged conditions are primary criteria for identifying candidate orderings that are potential culprits in relation to the trend of interest. However, when the data contains measurements that correspond to unacceptable levels, it is likely to be flagged with respect to more than one ordering. A significant unknown then becomes: which of the orderings that resulted in flagged conditions (a) are the most likely ones to point to the root causes of unacceptable data or (b) should be receiving priority in diagnostic activity. In answering this two-part question, various ranking factors play a key role. Note that orderings and tools that are emphasized in post-flagging diagnostic activity may not necessarily be the primary suspected contributors, but rather moderately suspect contributors with a potential to cause much greater damage if they indeed turn out to be contributors to unacceptable deviation. The ranking factors support directing the diagnostic effort. This diagnostic effort could involve, among other things, re-running of the monitoring system with a modified set of input parameters that specifically corresponds to a diagnostic mode. In other words, such diagnostic effort may be based on the data currently present in the system—but its analysis would be performed with diagnostics as an objective. Part of the special diagnostic runs may correspond to selecting the objects and time frames for the multi-orderable analysis, so as to achieve a higher level of uniformity between various orderings corresponding to the same variable or to eliminate data that is associated with behavior for which the engineering explanation is already available.

Diagnostic and root-cause finding efforts may also involve a number of other actions that directly impact the data, such as introduction of additional objects, temporary change in randomization policies and so forth.

Also, it should be noted that if the test objects passed through two different stations in exactly the same order, and the ordering was flagged, no information could be extracted to enable finding that one of the stations is a greater suspected contributor to the deviation than the other. In other words, there is no a-priori basis for declaring that the station used earlier in the test object stream is somehow more likely to have contributed to the deviation. Thus, special routing policies that perturb or randomize the order of the objects as they are routed to various stations are of special value in the context of multi-orderable data, since such policies help to accrue information on which stations have influence on a particular variable.

Ranking factors are computed based on data processing rules. Among the ranking factors is the magnitude of the detected condition, as well as its recency. The magnitude is a logarithmic quantity (similar to a value on a Richter scale) that measures the degree of deviation (by the multi-orderable data set) from acceptable behavior. It is measured as a function of p-values corresponding to a set of statistical tests used to determine whether a condition is flagged. Some components that go into computing the magnitude could be treated as ranking factors in their own right.

The magnitude alone, however, does not enable one to judge whether the detected condition is “newsworthy” for a user, because the detected condition might correspond to events that occurred a long time ago. The recency ranking factor reflects the relevance in time of the conditions that contributed to the high magnitude of the flagged observation event. For example, if all the observation events contributing to the alarm condition (e.g., on five (5) separate lines when the list is presented in the Table 1 structure) occurred 5 or more days ago (based on a time-stamp analysis), recency is defined as 5 days.

Flagging caused by threshold violations of one of the trend-revealing transforms is interpreted as an alarm condition. Ranking factors help to direct the diagnostic effort. When ranking the alarm conditions, the GUI apprises the user of all rules violations found in the data, even violations of low magnitude, provided that the recency is low. For example, a freshly brewing out-of-control condition is not likely to manifest itself as an event of high magnitude when it is first flagged, but nevertheless presented to the user/engineer for consideration. An event is a flagged condition for which the “Magnitude” ranking factor is particularly high. In fact, one could expect a pretty weak “Magnitude” rank in the initial stages. However, the “Recency” rank will be pretty high and it is this factor that could cause high priority to be assigned to this event.

The first detection of unexpected process behavior is likely to be in response to a very small amount of data moving from just with acceptable, to just within an unacceptable range. While such situations might be overlooked in a conventional perusal of process test data, the recency element accommodates so that the slight deviation is picked up in view of the event's low recency. Ranking detected observation events in accord with a magnitude in the multi-orderable data environment supports identifying the particular tool responsible for the event that leading to an alarm condition. It should be noted that one single event might cause the monitoring system to flag several tools (or processing stages of tools), where the magnitude is likely to be higher for tools that are associated with the root cause.

### Determining the Flagged Conditions

At any stage in a process monitored using the monitoring tool, the number of conditions to be explored (i.e., processed) is very high. That is, every variable can be sorted with respect to many different tools and every sorting of this type has to be evaluated. Hence, the invention includes evaluation routines that are very efficient. In the preferred embodiment, the invention uses repeated Cusum-Shewhart tests and, if needed, switches to use of more general repeated Likelihood Ratio tests. The Cusum-Shewhart tests are described, for example, in Yashchin (1985). The evaluation routines are normally applied to observations that are arriving sequentially in time: their Markovian structure is especially appealing under these conditions.

As used herein, a variable is a particular measurement (like oxide film thickness), which a user decides is significant for monitoring purposes, from which any deviation in the overall monitored process can be readily discernable. Once the variables are defined, the novel system and method apply the functions representing the various aspects of the defined variable. For example, the variable may be wafer mean, within-wafer variance, etc., where the objects under test are semiconductor wafers. The functions prepared to effectively monitor the variable result in monitoring sequences. To the monitoring sequences the trend-revealing transforms (the actual thresholds are applied to these transforms) are applied.

The variable can be time-ordered with respect to different stations. For example, it can be ordered with respect to the passage time through the oxide deposition tool, or with respect to passage time through a post-deposition oxide thickness measurement tool. If, for example, wafers are completely randomized after the deposition tool (and so they arrive at the measurement tool in random order), and the data is consistent with an unacceptable process level, then examining these two orderings provide an opportunity to establish whether the unacceptable condition occurred because of the deposition tool or because of the measurement tool. The ranking factor of “Magnitude” is likely to be higher for the tool that is truly associated with the root cause.

The system (200) applies these tests in multi-orderable data, where at every process stage, the whole sequence could be re-arranged and new measurements might be inserted. Such an arrangement is discernible from a table such as that depicted in Table 1. At any “next” point in time, any part of this table could undergo changes related to integration of new data into this multi-orderable set. Accordingly, tests have to be re-computed from scratch at processing stages where the analysis is performed, and it is far from obvious that Cusum-Shewhart tests would still be desirable under these conditions. In fact, techniques based on retrospective data analysis, segmentation or use of so-called “scan statistics” appears to be more natural candidates. Inventive use of these tests, therefore, represents use of a known methodology in the unusual multi-orderable data environment. Similarly, Likelihood Ratio tests such as those described in Yashchin (1995)), were not designed or recommended for analysis of multi-orderable data.

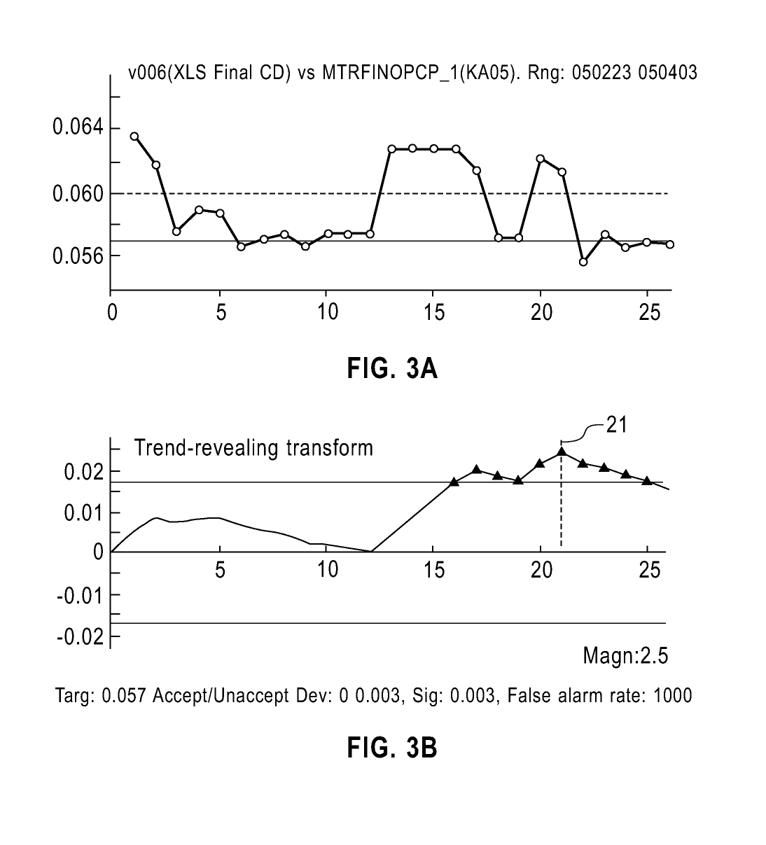

FIG. 3A depicts an example of the data for variable v006 (named “XLS Final CD”), which is sorted in accordance with the time stamp corresponding to passage through the station KA05 of the station group MTRFINOPCP_{—}1. This FIG. 3A shows 26 values (points) of v006 (the indices of these points are shown on the horizontal axis). As indicated in the plot header, these points correspond to the range of timestamps between Feb. 23, 2005 and Apr. 3, 2005. The FIG. 3A plot illustrates the property of the trend revealing transform. The trend revealing transform tends to increase (up or down, depending on the trend) as the level of monitored variable deviates from the target. The Magnitude associated with this analysis is 2.487 and the Recency is 21, as shown in the FIG. 3B plot. This Recency factor corresponds to point No. 21 in the Table 2 (its timestamp is Mar. 23, 2005), representing the last detected measurement still consistent with the unacceptable process level. Table 2 comprises corresponding sorted data corresponding to 26 points plotted in FIGS. 3A and 3B, and the Table 2 columns represent the index, Point identifier, Date, Time and the sorted measurement.

TABLE 2
v006(XLS Final CD) vs
MTRFIN0PCP_1(KA05). Rng: 050223 050403

| | | | | |
|---|---|---|---|---|
| 1 | 05010EWT005.000 | 050223 | 8:42:00 | 0.06361 |
| 2 | 05010KPT001.011 | 050224 | 16:55:00 | 0.06185 |
| 3 | 05050KGS032.000 | 050225 | 7:03:00 | 0.05764 |
| 4 | 05060KAI129.000 | 050228 | 19:16:00 | 0.05908 |
| 5 | 05060KGS112.000 | 050301 | 2:05:00 | 0.05881 |
| 6 | 05050KGS042.000 | 050303 | 6:25:00 | 0.05675 |
| 7 | 05070KGS098.000 | 050303 | 14:11:00 | 0.05723 |
| 8 | 05070KGS199.000 | 050307 | 14:19:00 | 0.05749 |
| 9 | 05070KGS198.000 | 050309 | 23:41:00 | 0.05682 |
| 10 | 05070KGS215.001 | 050310 | 16:06:00 | 0.05756 |
| 11 | 05070KGS215.000 | 050310 | 23:11:00 | 0.05756 |
| 12 | 05080KGS217.000 | 050311 | 14:19:00 | 0.05752 |
| 13 | 05070EWT002.000 | 050311 | 20:57:00 | 0.0629 |
| 14 | 05070EWT002.003 | 050311 | 20:57:00 | 0.0629 |
| 15 | 05070EWT002.001 | 050312 | 16:28:00 | 0.0629 |
| 16 | 05090ESM002.000 | 050313 | 1:14:00 | 0.06284 |
| 17 | 05080ESM004.000 | 050314 | 12:40:00 | 0.06148 |
| 18 | 05080KGS231.000 | 050317 | 2:42:00 | 0.05717 |
| 19 | 05070KGS141.000 | 050319 | 12:50:00 | 0.0573 |
| 20 | 05080ESM001.000 | 050319 | 19:25:00 | 0.06229 |
| 21 | 05100EWT002.000 | 050323 | 15:47:00 | 0.06142 |
| 22 | 05090KGS416.000 | 050326 | 18:29:00 | 0.05584 |
| 23 | 05090KGS328.000 | 050331 | 21:47:00 | 0.05748 |
| 24 | 05020KMS001.002 | 050401 | 2:50:00 | 0.05671 |
| 25 | 05100KGS363.000 | 050402 | 21:49:00 | 0.05698 |
| 26 | 05110KGS318.002 | 050403 | 5:36:00 | 0.05687 |

The sorting mechanism transforms data corresponding to the variable v001 into a sequence of scheme values {s₁, s₂, . . . , s_{T}}. Variable v001 is similar to the variable v006 shown in the example above. Scheme values reflect the state of the underlying process at the various processing steps, or stages. Variable v001 represents some property of the test object that should be monitored. The novel monitoring system and method flag in accordance with these scheme values. A variable such as v001 is automatically “selected” for a given tool (for example, in the exemplary Table 1) where its corresponding sequence of scheme values exceeds some threshold h. Scheme values are computed for all relevant orderings of v001, and so decision thresholds h vary from one ordering to another. The collection of scheme values is referred to as the “detection scheme” herein.

### Input Parameters

As mentioned above, the user/engineer, via the interactive GUI and the parameter generating module, communicates or defines which parameters based the defined decision rules. The parameter generating module accepts an input providing the minimal set of parameters including:
1. Type of Control (1-sided or 2-sided). The user decides whether to look for significant (i.e., flaggable) changes in a parameter in any of up, down and both directions with respect to the sampled data hierarchy. For example, when monitoring particle contamination, only a 1-sided observation is necessary because interest is focused on changes of mean contamination going up, not down, in most analyses. 2-sided control is effective for use under circumstances where detecting changes from the target level both “up” and “down” (e.g., when monitoring oxide film thickness).
2. Acceptable rate of false alarms (FA) is an indicator quantifying a number of observations (points), which on the average is required to develop a flagging condition for a process whose mean is considered acceptable.
3. Spec Deviation is an indicator that conveys the specification (spec) or spread for variable v001. In particular, Spec_Deviation is by default half of the (real or assumed) spec range. For example, where a Spec_Deviation=4 Angstroms, a deviation of greater than 4 angstroms in the v001 measurement from its target is automatically defined as “scrap-level” deviation.
4. Distribution family is a parameter reflecting the distributions for which the particular monitoring procedure is developed (for example, Gaussian (may be chosen as default), Gamma, etc.). Instead of providing this information, the user may merely specify a data set (for example, of type corresponding to Table 1), which corresponds to stable behavior of the variable of interest, v001. The parameter generating module (250) automatically converts this input to the set of working parameters that are kept in the parameter specification file. As used herein, input is a data set that enables one to discover automatically what type of distribution family (eg. Gaussian) is most suitable in a given situation.

The working set of parameters comprising a parameter specification file include:
1. A “best” or target level for the variable v001, identified as: Target.
2. An estimated standard deviation a of v001, identified as: a (i.e., Sigma).
3. Type of control (1-sided or 2-sided, both or inherited from automatic input), identified as: Type.
4. An acceptable deviation of the mean of v001 from the Target. The deviation parameter informs both the monitoring tool and user an amount of “wiggling room” inherent in the process mean relative the Target. A zero value means, for example, indicates there is no “wiggling room” at all. As long as the mean is within this acceptable deviation, the system flags, or defines same as a false alarm. In the case of 2-sided type of control, both acceptable deviations upward and downward are generated.
5. Unacceptable deviation of the mean of measurements from the Target informs the user of the particular process changes that were deemed significant when he/she structured his/her particular monitoring task, as described above. When a deviation of the process mean from the target reaches an “unacceptable” value, the system flags same, and the flag is conveyed to the user. Between acceptable and unacceptable deviation level lies a “gray zone.” For example, if the acceptable deviation of oxide thickness from the target is 10 Angstroms and the unacceptable deviation is 20 Angstroms, then a deviation of 15 Angstroms would be considered “in the grey zone”, i.e., it is neither acceptable not unacceptable. In the case of 2-sided type of control, both unacceptable deviations upward and downward are generated.

Acceptable/unacceptable levels are generated in one of two formats: absolute and delta. In a delta format, levels are presented relative to the Target. For example, where the Target=15, and acceptable/unacceptable deviations upwards and downwards are 1 and 3, respectively, the Target is readily adjusted without adjusting these acceptable/unacceptable deviations. This feature is particularly useful when processing metrology data. Acceptable and unacceptable levels in the absolute format can be 15+1=16, and 15+3=18. This format is useful with attribute data, or 1-sided control where levels are easily interpreted. For example, if a variable corresponds to counts of contaminating particles per wafer, a 1-sided procedure would be effective for detecting change in the mean of counts upwards, and declare 15 particles per wafer to be the target, the level of 16 particles/wafer to be an acceptable level (i.e., an alarm triggered when the actual process level is 16 is still considered a false alarm) and 18 particles/wafer to be the unacceptable level.

In the case of 1-sided control, the Target does not play a role in deciding whether a particular data set is flagged. The Target serves for purposes of graphical convenience only. In the case of 2-sided control Target is used to establish the acceptable, unacceptable and “grey” zones. In the delta-format the interpretation is that levels of v001 in the range 15 plus/minus 1=(14, 16) are acceptable, and levels outside the range, 15 plus/minus 3=(12, 18), are unacceptable. In the absolute format, if 2-sided control is required, and 15, 16, 18 are specified as Target, acceptable and unacceptable levels, respectively, then (as in the case above) it is once again assumed that the acceptable window is (14, 16), and unacceptable levels are outside the window (12, 18).

Unlike the 1-sided upper schemes, the 1-sided lower control schemes are intended for detection of changes in process level downwards. 1-sided lower control schemes are used, for example, to detect degradation of yield or speed. In the delta-format, lower schemes are implemented by the engineer/user requesting a 1-sided scheme and specifying negative acceptable/unacceptable levels (i.e., deviations). For example, with Target, acceptable and unacceptable levels 15, −1 and −3, it will be assumed that the level of 14 is still acceptable and the levels below 12 are unacceptable. In the absolute format, these inputs would be defined as 15, 14 and 12. Note that the unacceptable level is always farther from the Target than the acceptable level.

6. The acceptable rate of false alarms (inherited from automatic input) indicates how many observations (points), on average are required to develop a flagging condition for a process whose mean is at the edge of an acceptable level. For example, if the process target for v001 is 15, and acceptable and unacceptable deviations from the mean are 1 and 3, respectively, then the false alarm rate of 1000 means that if a process level reaches 15+1=16, then the detection process should generate 1 (false) alarm per 1000 points. Note that higher numbers for false alarm rate entry are associated with higher detection thresholds and with lower sensitivity, consequently.

Unacceptable Sigma factor (σ). This factor is used to detect changes in variability as expressed by Sigma. For example, a factor of 1.5 indicates that if this particular measure of variability reaches 1.5 times its nominal value, the measurement is to be expediently detected.

### Establishing Acceptable and Unacceptable Levels Based on the Minimal Set of Input Parameters.

A procedure (referred to herein after as “Procedure A”) is now described that is instrumental in auto-completing the parameter file when the user is only willing to specify a minimal set of input parameters. Procedure A is of special importance because in practice it may be difficult for the users to specify the acceptable and unacceptable levels, while quantities like the spec deviation v could be readily available, e.g., from the standard process capability analysis. Note that when the type of control is 1-sided, then the sign of the spec deviation points to the direction of change that one is sought to be detected. In particular, when v>0, the invention focuses on detecting changes up, and when v<0, the invention focuses on detecting changes down. In case where the type of control is 2-sided, the sign of v does not matter. But two-sided control generates two cases that are both accommodated by Procedure A described below:

Procedure A:
(1) If the target and standard deviation σ are both specified, then the acceptable deviation from the target, denoted Δ_{acc}, is computed via formula:

$${Δ}_{acc} = \{ \begin{matrix}0 & if d \leq a \\ k σ ( d - a ) & if d > a\end{matrix} \qquad ( 1 )$$

where (k, a) are some specified pair of numbers and d is given by the formula

d=|v/σ| (2)

Furthermore, the unacceptable deviation from the target, denoted Δ_{unacc}, is computed via formula:

$${Δ}_{unacc} = \{ \begin{matrix}σ {d}^{2} / {a}^{2} & if d \leq a \\ σ ( d - a + 1 ) & if d > a\end{matrix} \qquad ( 3 )$$

where d is given by (2). The values (Δ_{acc}, Δ_{unacc}) are then both taken with sign “+” if v>0, and with sign “−” if v<0. The values (k=0.5, a=5) is preferred, found to work well for Gaussian distributions. Note that if v>0 and the “type of control” parameter is indicated as 1-sided, then the obtained values (Δ_{acc}, Δ_{unacc}) will be used for detecting changes upwards. If, however, v>0 and the “type of control” parameter is indicated as 2-sided, then the obtained values (Δ_{acc}, Δ_{unacc}) will be used for the part of the detection scheme responsible for detection of changes upward, and the reflected values (−Δ_{acc}, −Δ_{unacc}) will be used for the part of the detection scheme responsible for detection of changes downwards.
(2) If either the target and standard deviation (or both) are unspecified, then they are estimated from the multi-orderable data source. The invention thereafter performs computations as in case (1), with these estimates substituted for the true values of the target and standard deviation.

### Manual Input/Adjustment Mode

As described above, the GUI provides the user/engineer access to the parameter file when setting up a monitoring task using the monitoring system (200) and method. In this set-up, the user is enabled to:
5. over-write parameters produced by the parameter generating module (250), which typically occurs after being not (completely) satisfied with the results of an analysis implemented in accordance with the current parameters.
6. input a full set of user-defined parameters before the parameter generating module is activated. In this case, the parameter generating module (250) does not replace the engineer/user's chosen parameter inputs.
7. input a partial set of parameters, before the parameter generating module is activated. In this case, the parameter generating module processes the inputs in accordance with an established processing hierarchy, and auto-completes the set of parameters. For example, if an engineer/user defines (inputs) a Target value into the parameter file (any value), then only the values of a and acceptable/unacceptable levels will be auto-filled by the parameter generating module (250). If the user inputs both Target and a, then only the acceptable/unacceptable levels are auto-filled. In the process of auto-completing the parameter file, the novel monitoring tool utilizes distribution family information, and/or the data set provided in entry (4) as input to the parameter generating module.

### Threshold Computations

Given the massive nature of the analysis conducted by the inventive monitoring tool, efficiently computing decision thresholds is particularly important for any analysis. The invention does so by approximating the set of scheme values by values of a suitably adjusted Brownian motion process. Such approximations are known for some of the tests, and they need to be derived for some others (for example, m2 defined below herein). The novel method then applies superposition of several tests and computes their statistical properties based on Brownian motion approximations and correlations between the tests, to derive a single flagging decision criteria based on said superposition.

During tool operation, flagging operation generates a nominal false alarm rate with deviation of no more than 10% to account for additional flagging rules. Flagging is achieved by applying thresholds to trend-revealing transforms incorporated in the monitoring system. The parameter file specifies the acceptable false alarm rate for a particular monitored variable. In practice, satisfying this requirement exactly might prove to be cumbersome, given possibility of several thresholds involved—therefore some “reasonable” allowance (like “within 10%”) could be implemented.

### Establishing Magnitude of the Analyzed Events

The system and method measure a Magnitude that reflects the priorities of the user for a particular characteristic of standard of the objects (products) monitored. All the analyses (flagged or non-flagged) are assigned a magnitude. Of special importance are analyses that end up being flagged. Note that the novel monitoring tool separates the selection and magnitude computation functions. That is, the monitoring tool does not flag based on magnitude computations, but rather based on schemes (produced by trend-revealing transforms) and their parameters, as described above. Magnitude (and its components) are used for root cause diagnostics and problems of detection and diagnostics.

At the time when a given variable, say v001, is flagged for the first time, there is a presumption that (a) prior evidence has already made clear that the variable is not behaving in a way considered “acceptable” and (b) there is still to little data available to diagnose the root cause of the problem. So, when flagging occurs, a whole range of new actions is taken, which is likely to generate new volumes of data specifically geared towards diagnosing the problem to an actionable level. Diagnosing the problem to an actionable level is different than the detection because the unacceptable behavior has been detected already. Thus, the problems of detection and diagnostics are inherently different, as they require different tools and data collection strategies.

A “root cause” identification is yet another example of flagging an indicator of a potential deviation, or problem. That is, if a user establishes that a problem is related to a given tool (diagnostics), and makes a decision to sideline the tool, there is no real data that establishes what went wrong with the tool. And a related problem is that of developing corrective actions, different from detection, diagnostics or search for a root cause, will typically require other solutions, or methods. The ranking factors produced by an analysis serve as a first step for guiding the diagnostic phase and directing the effort so as to minimize damage related to the flagged condition. Note that a ranking policy could assign a higher ranking factor to a condition that is not the “most likely” contributor to a deviation, simply for reasons of risk mitigation.

The following functions are used to determine magnitude:
(a) m₁=−log [Probability{maximal value of the score will exceed the actually observed value of max{sᵢ, s₂, . . . , s_{T}} given that the process level is at the upper edge of the acceptable level}]; and
(b) m₂=−log [Probability{final value of the score will exceed the actually observed value of s_{T} given that the process level is at the upper edge of the acceptable level}].

A detected magnitude m is the average of the component magnitudes, m=(m₁+m₂)/2, or some more complex function of the component magnitudes. Note that this type of computation assigns a higher magnitude to a data set containing good and bad conditions if the bad conditions occur more recently. However, the component m₁ is not focused on the most recent period, and so it is of higher value for diagnostic purposes. Since under conditions of acceptable behavior the correlation between s_{T} and max{s₁, s₂, . . . , s_{T}} is typically small, magnitude m is interpreted as a “Richter scale” magnitude corresponding to combinations of tests focused on different types of deviations from acceptable behavior. Such combinations occur when several trend-revealing transforms are applied to the same variable, resulting in several thresholds (e.g., separate thresholds for m1 and m2, above). The invention simplifies a battery of tests for the several thresholds by treating the problem as a “combination” (i.e., consolidating m1 and m2 into a single value like m using a formula of type shown above), and then applying just a single threshold.

Computation of the magnitudes m₁, m₂ includes Brownian motion approximations with appropriate adjustments. In particular, the method utilizes several known formulas for distribution of the Brownian motion value at an arbitrary point in time, which distribution is adjusted to account for special distributional properties of the data. For example, if a certain level of a trend-revealing transform s₁, s₂, . . . , s_{T} is observed that appears “high”, the novel system and method assigns a magnitude to it by computing the probability that particular characteristics of the transform, e.g., its maximal value as shown above, would be exceeded by a process whose behavior is considered acceptable. If this probability is very small, then it is an event of “high magnitude”. This magnitude could be formally measured as −log {this Probability}. Note that this measure of magnitude indeed becomes large when the Probability is small. Other measures of magnitude could also be feasible, but the invention chooses the logarithmic measure, under which the “magnitude” can be interpreted in a way similar to Richter scale.

### Establishing Recency

Recency of flagged conditions is particularly important in view of the fact that it is not derived based on data corresponding to the variable of interest, say, v001, but rather on the values of the scheme values {s₁, s₂, . . . , s_{T}}, and in view of the fact that the scheme values are used for flagging and establishing the magnitude values of flagged (and non-flagged) analyses. The algorithm declares a recency for v001 with respect to the particular tool. The recency value for the tool is set equal to T₀, where:
2. no violations by any single observation related to v001 of observation-specific threshold rules were detected (i.e., no “spikes” up or down of “flaggable” magnitude were detected) within a period of length T₀ preceding the current point in time (i.e., the time of the analysis);
3. if a recency analysis based on data observed within the period of length T₀ preceding the current point in time, with detection threshold h*≦h (where h*=h is a likely choice, but one could choose a more conservative, smaller value), no flaggable conditions are detected;
4. observations immediately preceding T₀ (counting from the current point in time) were contributing to increase in the values of scheme values; however, the first observation immediately following the point T₀ caused the scheme to go down.

In the example described above for variable v006, and FIGS. 3A and 3B, recency is established based on the point #21 on a bottom plot showing the values of trend-revealing transform s₁, s₂, etc. Basically this point is interpreted as the “most recent” one that was still associated with unacceptable process level. In essence, the computation of recency illustrated in the plot gives a “clean bill of health” to data observed after point #21 that corresponds to the dashed vertical line on the FIG. 3B and is marked on the plot. So, the flagged condition shown in the plot is not “too recent” because acceptable data has been seen coming since then (this data conforming to acceptable process is represented by points 22-26), i.e., the last 5 points shown on the plot of FIG. 3B. Formally, recency could be defined as time elapsed from the timestamp of point #21 to the present moment in time. When ranking flagged conditions by “recency”, they are effectively sorted by this elapsed time, ranking highest the conditions where no acceptable data whatsoever was observed in the recent period. Note that “freshly brewing” problems will generally be ranked low in terms of magnitude (because there is not yet enough data to see that the process state is very bad) but are ranked high in terms of Recency (because these conditions are currently relevant and no (or not enough) acceptable data yet has been seen.

The novel monitoring tool's analyses of upper and lower sets of scheme values are performed separately. In two-sided detection, recencies are computed as T_{0,upper} and T_{0,lower}, separately. Then, recency is set as T₀=min (T_{0,upper},T_{0,lower}). Computing recency of a one-sided procedure is implemented efficiently. In the first stage of locating the point in time that determines recency, like locating the point #21 in the included plot, the user inputs establish a window of search, starting from the time T (which is defined as an index of the final data point), and back in time to identify a first data index I, where index i<i0≦T satisfies the relation Sᵢ₀−sᵢ>h*. The one-sided recency index is then based on i0, keeping in mind that where there are no violations by any single observation related to v001, and adjusting the recency accordingly.

To illustrate application of the window of search (in time), consider the example data shown in FIG. 3, including exploring time windows going from the last point on the plot back into history. Eventually, the window becomes wide enough to “capture” point #21: but the process continues. Only after exploring windows going deeper into history than point #21 can it be determined that the “recency” ranking factor should be computed relative to point #21. Thus, going deeper into history, a pair of indices (i, i₀) that satisfy the relation sᵢ₀−sᵢ>h* is attempted to be established.

When exploring windows reaching back into history and arriving at a window covering point #21, there is still uncertainty that this point will define “recency”. The invention automatically explores wider windows until a difference of h* is identified in the scheme values, for example, stopping at the point #18. It is at this point, then that claim that #21 is indeed the “most recent bad point” is verified. So, the identified indices are i=18, i0=21.

### Outputs

For every monitoring application, the table summarizes for the user the outcome of the analysis. Table #3 represents a typical output. By use of the results in table 2, an engineer/user, through the GUI, queries any table entries, examines data sources, reports, charts, tables, outlier information, supplemental information. The list shows flagged variables. Notice that several entries could correspond to a given variable (eg. see v005), since it could be flagged for several orders corresponding to various operations or tools. The fields “Variable”, “Description”, “Operation ID” and “Tool” are sorting fields. “Recency” and “Magnitude” are ranking factors. As can be seen by a review of table 2, the output values are “selective”, inherently illustrating the precautions taken to avoid false alarms: of the 1234 analyses only 12 got selected, or flagged. Note that when table of this type is made available to a user via an interface, the sorting fields will typically also be manipulated via filtering mechanisms (for example, the user may only extract records corresponding to variable v015).

TABLE 3
(No. of analyses: 1234; No. of analyses flagged: 12)

| Variable | Description | Operation ID | Tool | Recency | Magnitude | Link |
|---|---|---|---|---|---|---|
| v005 | W0 AED Final CD | PCFC | -SP | 12 | 47.844 | view |
| v015 | FL XLS Final CD | PCFC | -SP | 1 | 26.304 | view |
| v005 | W0 AED Final CD | MTRFIN0W0P_1 | KA04 | 11 | 20.415 | view |
| v005 | W0 AED Final CD | RIES [symbol] COHFatW0P_1 | FK05 [symbol] PM3 | 1 | 13.425 | view |
| v005 | W0 AED Final CD | MTRFIN0W0P_1 | KA10 | 12 | 13.247 | view |
| v015 | FL XLS Final CD | PCFC | -SM | 48 | 12.43 | view |
| [symbol] | [symbol] | [symbol] | [symbol] | [symbol] | [symbol] | [symbol] |

[symbol]

indicates data missing or illegible when filed

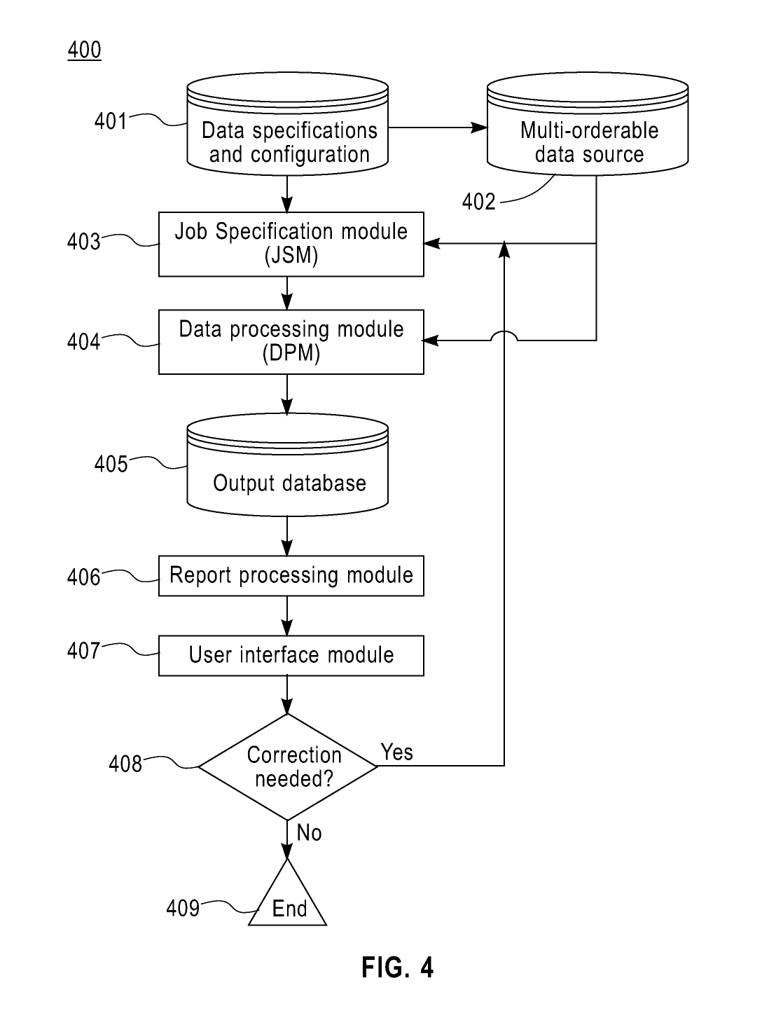

FIG. 4 depicts another embodiment of a system for monitoring multi-orderable measurement data (400) of the invention, presented in order to highlight system construction and operation. As shown in FIG. 4, a data specifications and configuration database (401) contains and provides specifications of the data source that spawns the multi-orderable data. In particular, database (401) describes the objects, stations and links of system (400). Multi-orderable data source database (402) contains and provides the actual multi-orderable data (for example, in the form of tables shown in Table 1) for use by the system. There are a number of formats in which multi-orderable data can be extracted from database (402).

Job specification module (JSM; 403) specifies the test objects for which measurements are defined, and receives input from the data specifications and configuration database (401) and multi-orderable data source database (402). The test objects enter the operational flow, move between processing stations and measurement stations, and eventually exit. JSM (403) specifies the measurements that serve as a basis of monitoring, and defines the processing parameters and a data processing schedule. Data processing module (404) is activated via a scheduler or on-demand, receiving input from JSM (403) and multi-orderable data source database (402). Data processing module (404) produces outputs such as logbooks, reports and tables. Such data processing module (404) outputs are stored in an output database (405). Report processing module (406) processes outputs from the output database (405), selects conditions to be flagged and assigns ranking factors to the conditions such as severity or recentness. User interface module (407) receives report processing module (406) outputs and organizes the output (such as Table 3, charts, reports) to be presented to the user.

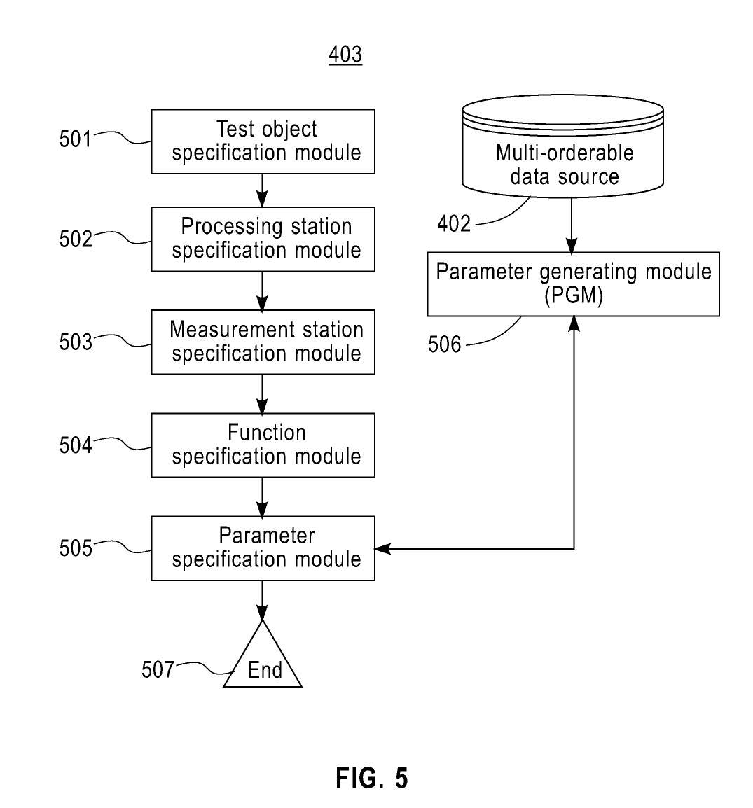

User interface module (407) receives data from report processing module (406), and provides for user input. In the system operational flow, a determination is made at (408) whether correction and adjustments are required. For example, if it is determined at decision step (408), that correction and adjustments are required, there is introduced modifications into JSM (403) to accommodate the intent and expectations of the end user. If no correction and adjustments are required, the program ends or exits (409). In general, after several initial runs the user will be satisfied with the configuration of a particular job and will leave it to run in a fully automated mode. Newer jobs, however, are expected to require users intervention, especially when they rely on the Parameter Generating Module (PGM) with a large number of unspecified parameters, which is part of the JSM (403) operation to be discussed in greater detail with the description of FIG. 5. After determining (at 408) that correction and adjustments are required, the user uses the processing results to further fine-tune the parameters of such jobs.

FIG. 5 depicts one embodiment of JSM (403), which is one component of the system for monitoring multi-orderable measurement data (400), depicted in FIG. 4. JSM (403) operates test object specification module (501) to specify the test objects. For example, a user can establish which wafers will be measured and under which conditions. Processing station specification module (502) receives the output from module (501), and allows for user input to select a subset of processing stations that are of interest. Measurement station specification module (503) receives the output from module (502) and receives user selections of a subset of measurement stations that are of interest. Function specification module (504) receives the output from module (503) and selects the functions of the measurements that will be monitored. For example, these functions could correspond to sample averages, variances or variance components. Parameter specification module (505) receives the output from module (504) and selects the parameters of the monitoring procedure. Preferably, a complete set of parameters is available for processing/monitoring every function specified in module (504). While such a complete set of parameters may be provided by user input, a semi-automated process of parameter specification is implemented by use parameter generating module (PGM; 506) interfacing with the multi-orderable data source (402).

PGM (506) is used for automatic generation of parameters (i.e., targets, estimated standard deviations, acceptable/unacceptable levels, etc.) upon the user's request for automated assistance and, outputs a parameter file that includes targets, estimated standard deviations, acceptable/unacceptable levels, etc. PGM (506) is capable of accepting the minimal number of parameters that must be user specified, and auto-completing the parameter file by computing the missing elements based on using mathematical algorithms in conjunction with the data contained in the multi-orderable data source 402. Program flow for JSM (403) ceases as indicated in End step (507).

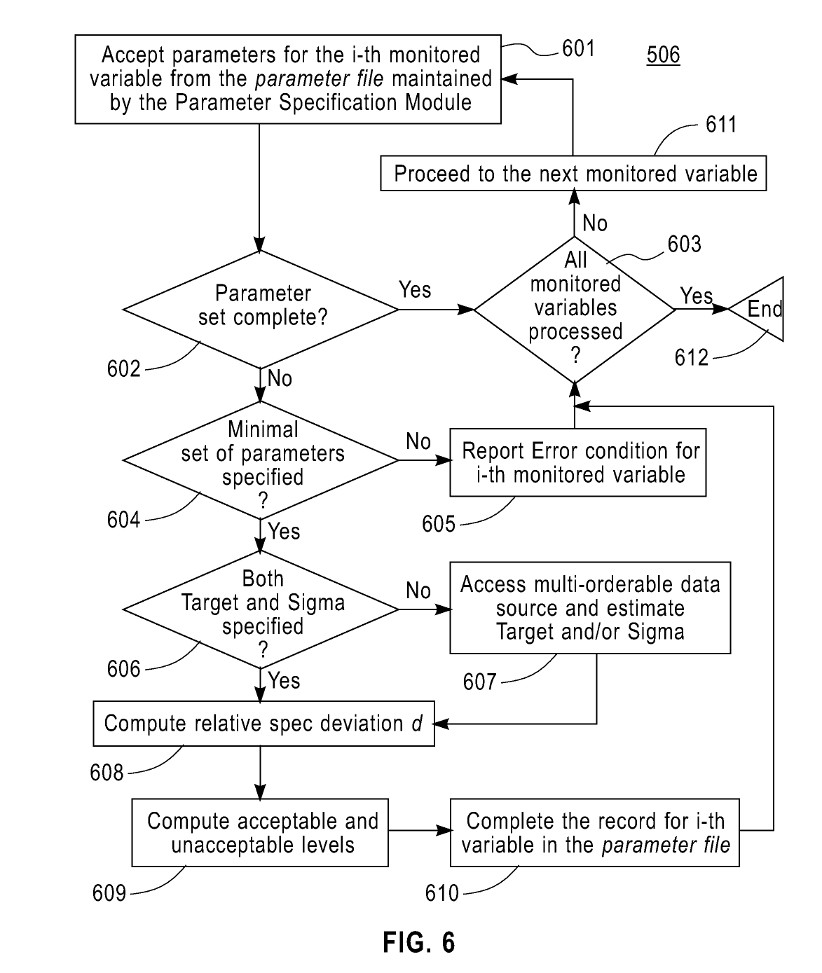

Operation of PGM (506) is depicted in FIG. 6. To operate PGM (506), a set of monitoring parameters must be specified for every monitored variable (601). The PGM accepts parameters, or sets of parameters for the i-th monitored variable from the parameter file maintained by the parameter specification module. PGM (506) also checks, for every variable, to what extent is its corresponding set of parameters specified, and auto-completes the set. In some cases, the PGM (506) requires access to the multi-orderable data source to auto-complete a set. Then, a determination is made at step (602) whether the parameter set is complete. If the parameter set is not complete, program flow advances to determine whether there is a “minimal set of parameters specified?” (604). If (at 602) it is determined that the parameter set is complete, then the process continues to determine whether all monitored variables are processed (603). If (at 603), it is determined that all monitored variables have not been processed, flow proceeds to the next variable (611), and back to step (601). If (at 603) it is determined that all monitored variables have been processed, the process flow ends (END; 612). PGM does not intervene.

Returning to step 604, it is determined that a minimal set of parameters has not been specified, an error condition for the I-th monitored variable is reported (at 605), and then process flow returns to the “all monitored variables processed?” determination step (603). If at step 604, it is determined that a minimal set of parameters has been specified, it is then determined whether “both Target and Sigma as described by the working set of parameters, see section “Input Parameters” are specified?” (606). If both target and sigma are not specified, the multi-orderable data source is accessed and target and/or sigma values are estimated (607). Otherwise, if both target and sigma have been specified, then a relative spec deviation “d” as defined by formula (2) is computed at (608), which receives the target and/or sigma values output from step (607). If the Target for the variable is not specified, PGM evaluates it based on the data source itself. Similarly, if the value of Sigma is not specified, PGM will access the data source so evaluate it. Process flow then progresses to a step where acceptable and unacceptable levels are computed in accordance with the Procedure A (609). The relative spec deviation d is the key for producing the acceptable and unacceptable process levels, using Procedure A described herein above. Thereafter, a record for the I-th variable is completed in the parameter file (at 610), and flow returns to step 603.

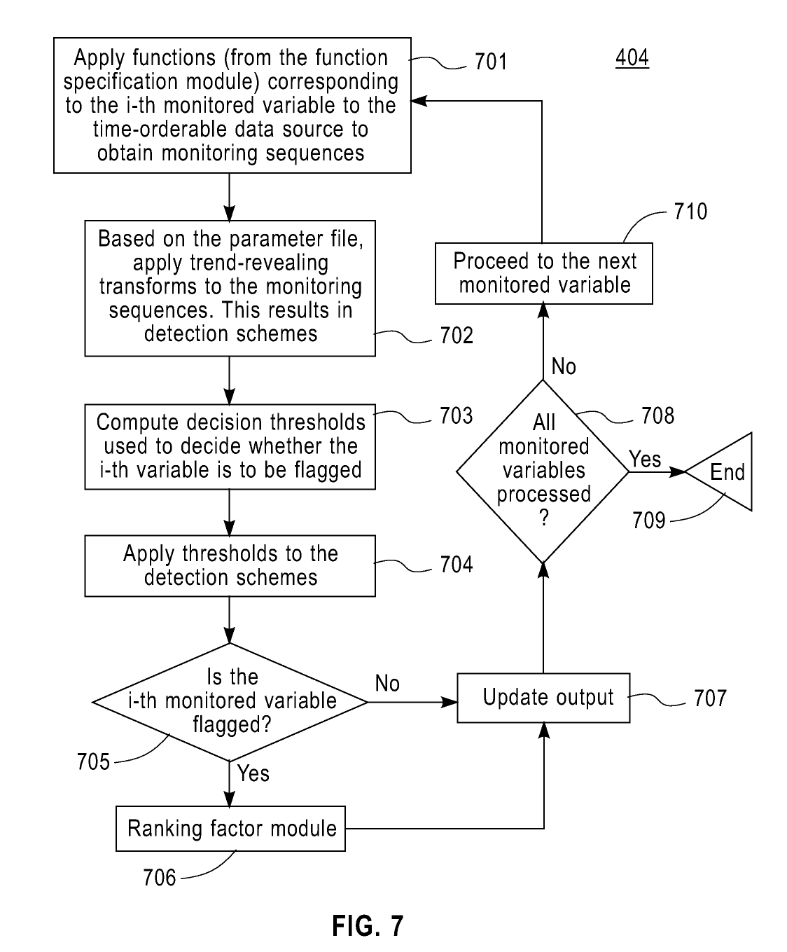

FIG. 7 depicts operation of data processing module (DPM; 404). In a first step (701), the module applies functions from the function specification module (504) corresponding to the I-th monitored variable to the time orderable data source to obtain monitoring sequences. Functions give a recipe for producing specific monitoring sequences. For example, a function could take multi-orderable data recorded on a wafer basis as an input, and then extract a set of averages for consecutive lots. Such a function is useful for monitoring lot averages (as opposed to wafer averages). The parameters corresponding to such a function are maintained in the parameter file. At the point where DPM 404 is activated, the parameter file is specified to the extent needed for data processing.

At step (702), based on the parameter file, trend-revealing transforms are applied to the monitoring sequences, resulting in detection schemes. That is, a trend-revealing transform is a recipe for transforming a given set of variables to the sequence of scheme values s₁, s₂, . . . , s_{T} that reflect the state of the underlying monitoring sequence process at consecutive points in time. These values are non-negative and they have a tendency to increase in response to an onset of a trend interested in being detected. At step (703), decision thresholds are used to decide whether the I-th variable is to be flagged. That is, computation of thresholds is based on the parameter file specifications, such as acceptable rate of false alarms, sensitivity requirements, and characteristics of variability. In step (704), thresholds to the decision schemes are applied. That is, in this phase the thresholds are applied and it is decided which monitored variables are flagged and what are the thresholds that have been violated.

Proceeding to decision step (705), the module determines whether the I-th monitored variable is flagged. If the I-th monitored variable is not flagged, the output is updated in step (707). If the I-th monitored variable is flagged, the ranking factor module associates ranking factors with the violated thresholds (706), which form a basis for sorting alarm conditions. This sorting can then be used for interactive data analysis and interpretation, for decisions on notification policies and corrective actions. In some implementations, ranking factors could be used even for monitoring sequences where no threshold violation was observed. From step 705 and 706, program flow progresses to step (707) and to decision step (708) where a determination is made as to whether all monitored variables have been processed. If all monitored variables have been processed, then the module process flow ends (709). If all monitored variables have not been processed, then flow progresses to step (710), where flow proceeds to the next variable, and the process returns to step (701).

Although a few examples of the present invention have been shown and described, it would be appreciated by those skilled in the art that changes might be made in these embodiments without departing from the principles and spirit of the invention, the scope of which is defined in the claims and their equivalents.

What is claimed is:

1. A method for monitoring a process comprising a number of process stages in order to maintain the process output at a specified quality standard by monitoring data derived from each process stage and arranged in a multi-orderable framework, and detecting whether multi-orderable data from each process stage is within a specified acceptable range, the method comprising:
for each process stage, arranging the measurement data from said process stage in a multi-orderable data framework;
for each process stage, monitoring the multi-orderable measurement data;
comparing the real-time multi-orderable data with expected parameter values corresponding to said each process stages;
detecting unacceptable deviations from the expected parameter values for said each process stage;
and
communicating the detected unacceptable deviations.

2. The method for monitoring a process as set forth in claim 1, wherein the step of communicating includes notifying appropriate personnel that there is unacceptable deviation in said process stage or feeding this information into an automatic response system.

3. The method for monitoring a process as set forth in claim 1, further comprising steps of:
generating supplemental information useful in identifying the root causes of the unacceptable deviation using said multi-orderable data; and
communicating said supplemental information to personnel in an effort to support an effort by the personnel to remedy the deviation or feeding this information into an automatic response system.

4. The method for monitoring a process as set forth in claim 1, wherein the step of arranging the measurement data from said process stage in a multi-orderable data framework includes setting a parameter value representative of a deviation from a target value; and
wherein the step of monitoring the multi-orderable measurement data monitors for said parameter value representative of the deviation from said target value.

5. The method for monitoring a process as set forth in claim 1, further comprising establishing recency of condition detected and flagged in the multi-orderable data that indicate a deviation.

6. The method for monitoring a process as set forth in claim 5, wherein the step of establishing recency includes one-sided analyses and two-sided analyses.

7. The method as set forth in claim 1, wherein the step of communicating includes generating a list of outcomes for each of the monitored process stages.

8. The method as set forth in claim 1, wherein the step of monitoring the multi-orderable measurement data for each process stage includes performing a step of statistical analysis to multi-orderable data streams.

9. The method as set forth in claim 1, wherein the step of detecting unacceptable deviations from the target parameter values for said each process stage based on a procedure for establishing acceptable and unacceptable parameter levels associated with each said process stage.

10. The method as set forth in claim 9, wherein the step of detecting unacceptable deviations utilizes a magnitude determining function that characterizes degree of the violation of the detected condition from an acceptable condition.
